(19) United States
(12) Patent Application Publication
(10) Pub. No.: US 2005/0248535 A1
(43) Pub. Date: Nov. 10, 2005

(54) Pointing devices

(75) Inventor: Anthony Mark Sawyer, Broadstone (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Advanced Input Devices (UK) Limited, Ringwood (GB)

(21) Appl. No.: 11/097,544

(22) Filed: Mar. 31, 2005

(30) Foreign Application Priority Data
Apr. 1, 2004 (GB) 0407461.3

(51) Int. Cl. G09G 5/08

(52) U.S. Cl. 345/167

(57) ABSTRACT

A ball 1 for use in a pointing device 19, the ball 1 having provided thereon a pattern 2 which is of a different optical reflectance to the remainder 6 of the ball, the pattern comprising a line running from a first point 3 on the ball to a second point 4 on the ball 1 along the general line of a spiral 5, said pattern including a plurality of lateral deviations 7 from the general line of the spiral 5 so that a movement of the ball 1 along the general line of the spiral 5 will still provide a detectable change in reflectance.

### FIELD OF THE INVENTION

This invention relates to improvements to pointing devices. Particularly preferred embodiments of the invention relate to improved trackballs, mice and joysticks that include a ball. Another preferred embodiment relates to a ball for use in such a pointing device, or any other item of equipment that makes use of a pointing device.

### BACKGROUND TO THE INVENTION

Pointing devices, such as mice and trackballs, are well-known devices that can be used in computer systems to facilitate the control of a pointer depicted on a display screen. Pointing devices also find utility in other items of equipment where it is desired to move a pointer on a screen (such as certain items of medical equipment) or to control peripherals such as robotic arms.

With a mouse, a user controls the pointer by moving the mouse and the pointer moves a direction and distance proportional to the movement of the mouse.

Some mice make use of changes in light reflectance as the mouse is moved over a surface, and others use a mechanical approach where movement of the mouse causes a ball inside the mouse to rotate and drive so-called shaft encoders—those encoders being associated with appropriate sensing devices that translate rotation of the encoder shafts into signals which are indicative of the rotation imparted to the ball and hence the movement of the mouse.

In one such prior art device the shaft encoders each include a slotted wheel that is arranged to rotate between a light source, often an LED, positioned on one side of the encoding wheel, and a photosensor, such as a phototransistor, positioned generally opposite the light source.

Rotation of the slotted wheel causes a series of light pulses to be received by the photosensor, by which the rotational movement of the ball can be converted into a series of signals that are representative of the rotation of the ball.

The operation of a trackball is similar to that of a mouse, although many structural differences exist. In a trackball, the device remains stationary while the user rotates the ball with the thumb, fingers or palm of the hand.

Trackballs can, as with the mouse, be essentially mechanical (wherein the ball engages a pair of shaft encoders), or optomechanical (wherein the shaft encoders have slotted wheels thereon as aforementioned).

Although such a prior art approach has worked well for some time, the mechanical elements of such pointing devices necessarily limit the useful life of the device.

To avoid the use of mechanical components it has recently been proposed to provide a wholly optical pointing device, by which we mean that the sensing of rotation of the ball has no mechanical components whatsoever.

GB 2 27 1847, the content of which is incorporated herein by reference, discloses one such device. The optical pointing device (in this particular instance the pointing device is a trackball) which includes a ball, one or more light emitters which are arranged to illuminate the ball and an optical detector which is arranged to detect light reflected from the surface of the ball. The ball is of a first colour and is formed with a randomly distributed pattern of speckles of a second colour, the different colours giving rise to changes in the quantity of light reflected (and hence detected) as the ball is rotated.

Whilst this arrangement functions adequately for the purpose for which it was designed, it would appear that the manufacture of a ball with a randomly distributed pattern of speckles is problematic. In particular, it would appear to be difficult to ensure that the pattern provided on the ball is random, and to ensure that the speckles are all of an appropriate size. It would also appear that the provision of speckles over the entire surface of the ball is necessarily quite time consuming.

### SUMMARY OF THE INVENTION

It is an object of the invention to provide a ball and associated pointing device which can be more easily manufactured than the ball disclosed in GB 2 271 847.

The invention provides a ball for use in a pointing device, the ball having provided thereon a pattern which is of a different optical reflectance to the remainder of the ball, the pattern comprising a line running from a first point on the ball to a second point on the ball along the general line of a spiral, said pattern including a plurality of lateral deviations from the general line of the spiral so that a movement of the ball along the general line of the spiral will still provide a detectable change in reflectance.

The invention includes a trackball or mouse comprising:

a ball having provided thereon a pattern which is of a different optical reflectance to the remainder of the ball, the pattern comprising a line running from a first point on the ball to a second point on the ball along the general line of a spiral, said pattern including a plurality of lateral deviations from the general line of the spiral;

means for illuminating the ball;

means for detecting light reflected by the ball, and

means operable to determine, from said detected light and on rotation of the ball, the extent and direction of the rotation; and to generate signals indicative of the extent and direction of the rotation for the control of the position of a pointer displayed on a screen.

The invention includes a ball for use in a pointing device, the ball having an exterior surface having an optical reflectance and a pattern provided on said surface, which pattern is of a different optical reflectance to the optical reflectance of the surface, the pattern comprising a line running from a first point on said surface to a second point on said surface along the general line of a spiral, said pattern including a plurality of lateral deviations from the general line of the spiral so that a movement of the ball along the general line of the spiral will still provide a detectable change in reflectance.

The invention includes a pointing device comprising:

a ball having an exterior surface having an optical reflectance and a pattern provided on said surface which is of a different optical reflectance to said optical reflectance of said surface, the pattern comprising a line running from a first point on the ball to a second point on the ball along the general line of a spiral, said pattern including a plurality of lateral deviations from the general line of the spiral;

at least one illuminating device for illuminating the ball;

at least one detecting device for detecting light reflected by the ball; and

a device operable to determine, from said detected light and on rotation of the ball, the extent and direction of the rotation and to generate signals indicative of the extent and direction of the rotation for the control of a pointer displayed on a screen.

The invention includes a method of manufacture of a pointing device, said method comprising:

providing a ball having a surface that has a first optical reflectance; and providing a wavy spiralling line on said surface, said line having a second optical reflectance that is different to said first optical reflectance.

As will readily be appreciated by those of ordinary skill in the art, manufacture of a ball according to embodiments of the invention is advantageous in comparison with the manufacture of a ball as disclosed in GB 2 271 847 since it is not necessary to mark the entire surface of the ball to provide a ball (hence reducing the time required to manufacture the ball) or provide a random distribution of marks on the ball.

Other features and advantages of the present invention will become apparent when the following illustrative description is read in conjunction with the attached drawings.

### BRIEF DESCRIPTION OF THE DRAWINGS

A preferred embodiment of the present invention will now be described, by way of example only, with reference to the accompanying drawings, in which:

FIG. 1 is a schematic illustration of a ball in accordance with a preferred embodiment of the invention;

FIG. 2 is a schematic illustration, in a linear form, of the pattern applied to the ball of FIG. 1; and

FIG. 3 is a schematic illustration of a pointing device including the ball depicted in FIG. 1.

### DETAILED DESCRIPTION OF A PREFERRED EMBODIMENT

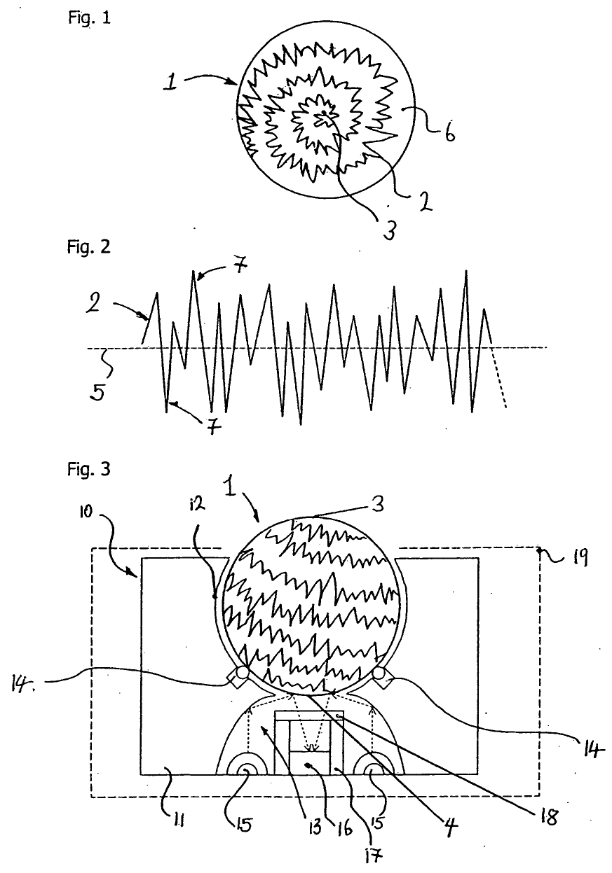

Referring now to FIGS. 1 and 2, there is depicted respectively a schematic plan view of a ball in accordance with a preferred embodiment of the invention, and a linear view of the pattern provided on the ball.

As shown, the ball 1 is provided with a pattern that consists of a line 2 which extends from a top point 3 of the ball 1 to a bottom point 4 (FIG. 3), and which follows the general shape 5 of a spiral (shown linearly in FIG. 2). In all other respects (e.g. size and/or materials) the ball is the same that those commonly used in the prior art.

The line 2 is optically detectable with respect to the remainder 6 of the ball, and this could mean that the line is of a different colour to that of the remainder 6 of the ball.

Alternatively, the line could only be visible under illumination by a particular type of light. For example, the line may be visible and hence detectable under ultra-violet illumination, the remainder of the ball being undetectable. In general terms all that is required is that the line has a different reflectance to that of the remainder of the ball so that the line is detectable with respect thereto.

As will immediately be appreciated by those of ordinary skill in the art, a spiral pattern can easily be formed on the ball by—for example—a printer that is held stationary as the ball is rotated past the print head of the printer. As the pattern need not be formed over the entire surface of the ball, the pattern forming process can be concluded that much more quickly.

As depicted in FIG. 1, the line 2 does not follow an exact spiral from the top point 3 to the bottom point 4 of the ball 1. Rather, the pattern includes a plurality of lateral deviations 7 (both above and below) from the general shape 5 of the spiral. In effect, the pattern marked on the ball could be described as being akin to a “wiggly spiral”.

The deviations 7 are provided to avoid problems that might otherwise result if the ball 1 were to be moved (manually or by moving the mouse housing) in a direction that aligned exactly with the general line of the spiral. By providing deviations of the kind depicted any movement along the spiral will still give rise to a detectable change in reflectance.

Any rotation of the ball will give rise to changes in reflectance that can be detected, and with the aid of appropriate software and hardware (such as for example that which is disclosed in the aforementioned prior art UK patent) these changes in reflectance can be converted to signals that are indicative of the rotation of the ball. These signals can then be utilised to control the position of a pointer on the screen of, for example, a computer system.

The marking on the ball depicted in FIG. 1 may be provided by printing onto the ball, by means of a laser, or by any other means (e.g. etching). The only overriding requirement is that the surface of the finished ball 1 should be relatively smooth, and this could be accomplished (in situations where the marking removes part of the surface of the ball) by applying a transparent coating to the ball once the marking has been applied.

FIG. 3 is a schematic representation of a ball cage 10 for a pointing device using the ball depicted in FIG. 1.

As shown, the cage 10 comprises a housing 11 formed with a cavity 12 in which the ball 1 is received in use, and a compartment 13 therebelow. The cage is enclosed within an outer housing of the trackball (indicated generally by reference numeral 19), and the outer housing includes an aperture to permit access to the ball. The ball is biased from the inner wall of the cavity 12 by means of one or more supports 14 (two of which are shown, and three of which are typically provided). In the preferred arrangement, the supports comprise ball bearings which are free to rotate in mountings provided in the inner wall of the cavity 12, and which thereby permit the ball 1 to rotate freely.

In a preferred arrangement, part of the housing 11 is removable to enable the ball 1 and the interior of the pointing device to be cleaned.

A plurality of light emitters 15 (in this instance LEDs) are provided within the compartment 13, and in the preferred arrangement the walls of the compartment are configured so that light from the LEDs does not directly impinge on the ball, but is instead reflected from the walls of the compartment onto the ball.

A light detector 16 housed in a housing 17 provided within the compartment 13. The housing 17 being provided to prevent light from the LEDs directly impinging on the detector 16. An optical lens 18 may be formed or provided on top of the housing to direct light reflected off the ball 1 into the housing 17 and onto the detector 16.

In the preferred arrangement the detector 16 comprises a charge coupled device (CCD) array tailored for detection of the particular type of light emitted by the LEDs.

The detector is coupled to control and determination circuitry which is operable to determine, from images of the ball captured by the detector, the rotation imparted to the ball 1 and to generate appropriate signals for passing to a computer system, for example, for the control of a pointer on the screen of that system. For efficacy, the circuitry will not be described in detail herein, the reader being referred to GB 2 271 847 for full details of suitable circuitry. Note should be made that the scope of the invention is not limited to the control circuitry described in GB 2 271 847 and many alternative arrangements apparent to those persons of ordinary skill in the art may be used instead.

Having described a preferred embodiment of the invention, it will be appreciated by those of ordinary skill in the art that modifications and alterations may be made to the embodiment disclosed without departing from the scope of the present invention as defined in the claims.

For example, whilst it is preferred for the ball to be bathed in diffuse light reflected of the walls of the compartment 13. This need not be required if the level of illumination from the light emitters 15 is not so great as to flood the optical detector.

As a further example, it will be apparent that the light emitters 15 need not be LEDs. All that is essential is for the emitters to emit a flavour of light that is appropriate for illumination of the line 2, and is appropriate for permitting discrimination between the line 2 and the remainder 6 of the ball 1.

A final point to note is that whilst particular combinations of claims have been presented, the scope of the invention is not limited thereto but extends to any combination or permutation of features described herein irrespective of whether or not that particular combination or permutation has been explicitly enumerated in the claims.

1. A ball for use in a pointing device, the ball having an exterior surface having an optical reflectance and a pattern provided on said surface, which pattern is of a different optical reflectance to the optical reflectance of the surface, the pattern comprising a line running from a first point on said surface to a second point on said surface along the general line of a spiral, said pattern including a plurality of lateral deviations from the general line of the spiral such that a movement of the ball along the general line of the spiral will still provide a detectable change in reflectance.

2. A ball according to claim 1, wherein said pattern is of a first colour and said surface is of a second contrasting colour.

3. A ball according to claim 2, wherein the pattern is black and said surface is white.

4. A ball according to claim 2, wherein said surface is black and the pattern is white.

5. A ball according to claim 1, wherein the pattern is undetectable on illumination by white light and detectable on illumination by a predetermined wavelength or range of wavelengths of light.

6. A ball according to claim 1, wherein said deviations extend to either side of said general line.

7. A ball according to claim 1, wherein said pattern is continuous.

8. A ball according to claim 1, wherein said first and second points are axially opposite one another.

9. A pointing device comprising a ball according to claim 1.

10. A pointing device comprising:
a ball having an exterior surface having an optical reflectance and a pattern provided on said surface which is of a different optical reflectance to said optical reflectance of said surface, the pattern comprising a line running from a first point on the ball to a second point on the ball along the general line of a spiral, said pattern including a plurality of lateral deviations from the general line of the spiral;
at least one illuminating device for illuminating the ball;
at least one detecting device for detecting light reflected by the ball; and
a device operable to determine, from said detected light and on rotation of the ball, the extent and direction of the rotation and to generate signals indicative of the extent and direction of the rotation for the control of a pointer displayed on a screen.

11. A pointing device according to claim 10, wherein said at least one illuminating device comprises at least one LED.

12. A pointing device according to claims 10, wherein said at least one illuminating device is configured to illuminate the ball with diffuse light.

13. A pointing device according to claim 12, wherein the ball is at least partially housed in a housing and said diffuse light is generated by reflecting light emitted by said at least one illuminating device off a wall of said housing and onto the ball.

14. A pointing device according to claim 10, wherein said at least one detecting device comprises a CCD array.

15. A pointing device according to claim 10, wherein the at least one detecting device is shielded from direct illumination by said at least one illuminating device.

16. A pointing device according to claim 15, wherein said at least one light detecting device is located within a housing.

17. A pointing device according to claim 16, wherein said housing includes a device for directing light reflected from the ball into the housing.

18. A pointing device according to claim 17, wherein said directing device comprises a lens.

19. A trackball comprising a pointing device according to claim 10.

20. A mouse comprising a pointing device according to claim 10.

21. A computer system comprising a pointing device according to claim 9.

22. A computer system comprising a trackball according to claim 19.

23. A computer system comprising a mouse according to claim 20.

24. A method of manufacture of a pointing device, said method comprising:
providing a ball having a surface that has a first optical reflectance; and providing a wavy spiralling line on said surface, said line having a second optical reflectance that is different to said first optical reflectance.

25. A method according to claim 24, wherein said wavy spiralling line comprises irregular waves.

26. A method according to claim 24, wherein said wavy spiralling line is provided by rotating said surface with respect to a fixed printing device which prints said wavy spiralling line on said surface.

27. A method according to claim 24, comprising providing a plurality of said wavy spiralling lines on said surface.

28. A method according to claim 24, wherein said line is defined by a series of discrete marks provided on said surface.
